(19) United States
(12) Patent Application Publication
(10) Pub. No.: US 2004/0078389 A1
(43) Pub. Date: Apr. 22, 2004

(54) System and method for locating images

(76) Inventor: David O. Hamilton, Ramona, CA (US)

Correspondence Address: HEWLETT-PACKARD COMPANY, Intellectual Property Administration, P.O. Box 272400, Fort Collins, CO, 80527-2400, US

(21) Appl. No.: 10/273,318

(22) Filed: Oct. 17, 2002

(51) Int. Cl. G06F 17/00

(52) U.S. Cl. 707/104.1

(57) ABSTRACT

A method for presenting a previously stored image, includes associating a first date with at least one stored image, displaying a plurality of dates, including the first date, while the dates are being displayed and in response to the first date being associated with at least one stored image, differentiating the displayed first date.

### BACKGROUND

Images (e.g., digital images, analog images, video clips) are often stored electronically. It can some times be difficult to locate a stored image. Improved ways are needed to identify and retrieve stored images.

### SUMMARY

An embodiment of a method for presenting a date associated with a previously stored image includes, associating a first date with at least one stored image, displaying a plurality of dates, including the first date, while the dates are being displayed and in response to the first date being associated with at least one stored image, differentiating the displayed first date.

### BRIEF DESCRIPTION OF THE DRAWINGS

A system and method for image processing are illustrated by way of example and not limited by the implementations depicted in the following drawings. The components in the drawings are not necessarily to scale. Emphasis instead is placed upon clearly illustrating the principles of the present system and method. Moreover, in the drawings, like reference numerals designate corresponding parts throughout the several views.

FIG. 1 is a schematic diagram illustrating an embodiment of an image-processing system according to the present system and method.

FIG. 2 is a functional block diagram of the general-purpose computer of FIG. 1.

FIG. 3 is a functional block diagram of an embodiment of the image-processing engine of FIG. 2.

FIGS. 4A-4E are embodiments of graphical-user interfaces operable on the general-purpose computer of FIG. 2 according to the present system and method.

FIG. 5 is a flow chart illustrating an embodiment of a method for displaying images that may be implemented by the image-processing system of FIG. 1.

FIG. 6 is a flow chart illustrating an embodiment of a method for displaying a date associated with an image that may be implemented by the image-processing system of FIG. 1.

### DETAILED DESCRIPTION

An improved image-processing system having been summarized above, reference will now be made in detail to the description of the system and method as illustrated in the drawings. For clarity of presentation, the image-processing system (IPS) and an embodiment of the underlying image-processing engine (IPE) will be exemplified and described with focus on the generation of a composite representation of images. As will be explained below, an image can be acquired by, or otherwise received by, a general-purpose computer within the IPS from an image-acquisition device such as a scanner, a digital camera, a video source, a multiple-function device (i.e., a device capable of scanning, copying, printing, faxing, etc.) or a data-storage device (e.g., in the form of a file transferred via an interface or read from a data-storage medium), among others.

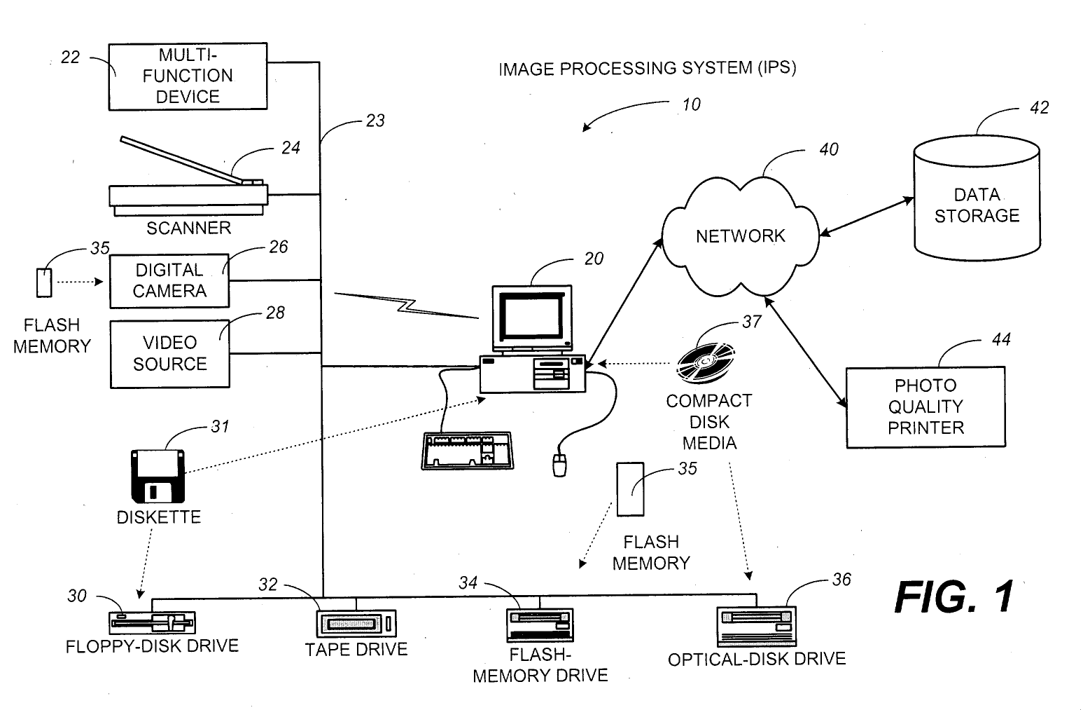

Turning now to the drawings, wherein like reference numerals designate corresponding parts throughout the drawings, reference is made to FIG. 1, which illustrates a schematic of an embodiment of an IPS 10. As illustrated in the schematic of FIG. 1, IPS 10 includes at least one image source and a general-purpose computer 20. The general-purpose computer 20 is communicatively coupled to a network 40 to enable an operator of the general-purpose computer 20 to access, print, distribute, or otherwise process images via network-coupled devices, such as data-storage device 42 and photo-quality printer 44. In operation, IPS 10 communicates with any of a number of image-acquisition and/or image-storage devices to receive, store, edit, or otherwise process images.

The embodiment illustrated in FIG. 1 depicts a number of image-source devices that are operable with IPS 10. For example, images can be acquired by general-purpose computer 20 via communication interface 23 and multi-function device 22, scanner 24, digital camera 26, video source 28, floppy-disk drive 30, tape drive 32, flash-memory drive 34, or optical-disk drive 36. The image source can be a document, a photographic print, among other items that may be recorded by an image-recording subsystem within the image capture devices. Alternatively, the image source can be a pre-recorded representation of an image or a series of images such as a video stored on a diskette 31, a flash-memory device 35, a compact-disk (CD) medium 37, a magnetic tape (not shown) or other data-storage media.

The communication interface 23 can be of a different type for each image-acquisition and data-storage device operable with the general-purpose computer 20 including, for example, serial, parallel, universal serial bus (USB), USB II, the institute of electrical and electronics engineers (IEEE) 1394 “Firewire,” or the like. The communication interface 23 may use a different standard or proprietary communications protocol for different types of image sources.

The image source can be a flash-memory drive 34 into which flash-memory device 35 is inserted. Flash-memory device 35 preferably contains a file system, and the combination of flash-memory device 35 and flash-memory drive 34 preferably implements a communications protocol such as the mass-storage device class protocol or the like for the transfer of images to the general-purpose computer 20. The image source may further be an optical scanner 24. The scanner 24 may communicate with the general-purpose computer 20 using any type of protocol or protocols.

Digital camera 26 may be any image-capture system that focuses an image on a sensor and converts the image into a two-dimensional array of picture elements (commonly referred to as “pixels”). Each pixel includes digital (i.e., numeric) information describing the colors and intensity of that pixel. The digital information in the array of pixels can be used by suitably configured devices (e.g., general-purpose computer 20, photo-quality printer 44, etc.) to create a rendition of the captured image. As illustrated in FIG. 1, digital camera 26 may be configured to store or otherwise transfer captured images from an internal memory to a flash-memory device 35. In addition, digital camera 26 can receive previously captured images stored on a flash-memory device 35. Images captured by the digital camera 26 and/or received via flash-memory device 35 can be transferred to the general-purpose computer 20 via communication interface 23 as described above.

Video source 28 may be a video-capture system that converts an analog-video signal into a digital format, or a digital-video device such as a digital camcorder, a digital-video disk (DVD) player, or the like. Image frames captured and/or reproduced by video source 28 can also be forwarded to general-purpose computer 20.

Any combination of image-acquisition devices and/or data-storage devices may be included in IPS 10. In addition, IPS 10 may contain more than one image source of the same type. IPS 10 may further include devices to which an image captured or otherwise acquired from an image-acquisition device or a data-storage device can be sent. Such devices include a photo-quality printer 44 (which may be of any type capable of printing an image but which is preferably a high-quality color printer and a data-storage device 42. Photo-quality printer 44 and data-storage device 42 may be coupled to the general-purpose computer 20 via a communications interface, which provides a connection to network 40.

Network 40 can be any local area network (LAN) or wide area network (WAN). When the network 40 is configured as a LAN, the LAN could be configured as a ring network, a bus network, and/or a wireless-local network. When the network 40 takes the form of a WAN, the WAN could be the public-switched telephone network, a proprietary network, and/or the public access WAN commonly known as the Internet. The communications interface may provide LAN, WAN, dial-up, or high-speed (e.g., digital subscriber line (DSL) connection to network 40.

Regardless of the actual network 40 used in particular embodiments, image data can be exchanged over the network 40 using various communication protocols. For example, transmission-control protocol/Internet protocol (TCP/IP) may be used if the network 40 is the Internet. Proprietary image-data communication protocols may be used when the network 40 is a proprietary LAN or WAN. While the IPS 10 is illustrated in FIG. 1 in connection with the network-coupled data-storage device 42 and photo-quality printer 44, IPS 10 is not dependent upon network connectivity.

Those skilled in the art will appreciate that various portions of IPS 10 can be implemented in hardware, software, firmware, or combinations thereof. In an embodiment, IPS 10 is implemented using a combination of hardware and software or firmware that is stored in memory and executed by a suitable instruction-execution system. If implemented solely in hardware, as in an alternative embodiment, IPS 10 can be implemented with any or a combination of technologies which are well-known in the art (e.g., discrete-logic circuits, application-specific integrated circuits (ASICs), programmable-gate arrays (PGAs), field-programmable gate arrays (FPGAs), etc.), or later developed technologies. In an embodiment, the functions of the IPS 10 are implemented in a combination of software and data executed and stored under the control of the general-purpose computer 20. It should be noted, however, that the IPS 10 is not dependent upon the nature of the underlying computer in order to accomplish designated functions.

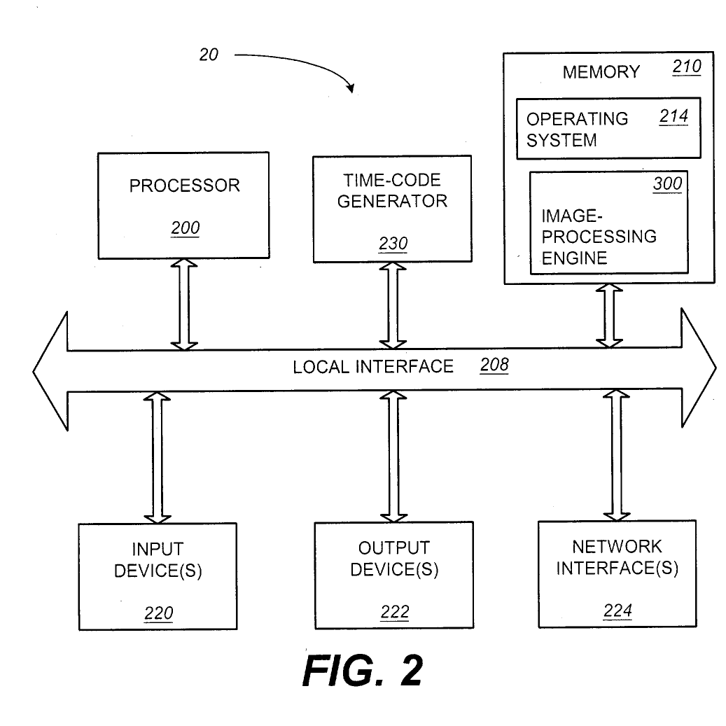

Reference is now directed to FIG. 2, which illustrates a functional block diagram of the general-purpose computer 20 of FIG. 1. Generally, in terms of hardware architecture, as shown in FIG. 2, the general-purpose computer 20 may include a processor 200, memory 210, input device(s) 220, output device(s) 222, network interface(s) 224, and time-code generator 230 that are communicatively coupled via local interface 208.

Local interface 208 can be, for example but not limited to, one or more buses or other wired or wireless connections, as is known in the art or may be later developed. Local interface 208 may have additional elements, which are omitted for simplicity, such as controllers, buffers (caches), drivers, repeaters, and receivers, to enable communications. Further, local interface 208 may include address, control, and/or data connections to enable appropriate communications among the aforementioned components of the general-purpose computer 20.

In the embodiment of FIG. 2, the processor 200 is a hardware device for executing software that can be stored in memory 210. The processor 200 can be any custom-made or commercially-available processor, a central-processing unit (CPU) or an auxiliary processor among several processors associated with the general-purpose computer 20 and a semiconductor-based microprocessor (in the form of a microchip) or a macroprocessor.

The memory 210 can include any one or combination of volatile memory elements (e.g., random-access memory (RAM, such as dynamic-RAM or DRAM, static-RAM or SRAM, etc.)) and nonvolatile-memory elements (e.g., read-only memory (ROM), hard drives, tape drives, compact-disk drives (CD-ROMs), etc.). Moreover, the memory 210 may incorporate electronic, magnetic, optical, and/or other types of storage media now known or later developed. Note that the memory 210 can have a distributed architecture, where various components are situated remote from one another, but accessible by processor 200.

The software in memory 210 may include one or more separate programs, each of which comprises an ordered listing of executable instructions for implementing logical functions. In the example of FIG. 2, the software in the memory 210 includes image-processing engine (IPE) 300 that functions as a result of and in accordance with operating system 214. The operating system 214 preferably controls the execution of computer programs, such as IPE 300, and provides scheduling, input-output control, file and data management, memory management, and communication control and related services.

In an embodiment, IPE 300 is one or more source programs, executable programs (object code), scripts, or other collections each comprising a set of instructions to be performed. It will be well understood by one skilled in the art, after having become familiar with the teachings of the system and method, that IPE 300 may be written in a number of programming languages now known or later developed.

The input device(s) 220 may include, but are not limited to, a keyboard, a mouse, or other interactive-pointing devices, voice-activated interfaces, or other operator-machine interfaces (omitted for simplicity of illustration) now known or later developed. The input device(s) 220 can also take the form of an image-acquisition device (e.g., the scanner 24) or a data-file transfer device (e.g., floppy-disk drive 30). Each of the various input device(s) 220 may be in communication with the processor 200 and/or the memory 210 via the local interface 208. Data received from an image-acquisition device connected as an input device 220 or via the network interface device(s) 224 may take the form of a plurality of pixels, or a data file.

The output device(s) 222 may include a video interface that supplies a video-output signal to a display monitor associated with the respective general-purpose computer 20. Display devices that can be associated with the general-purpose computer 20 are conventional CRT based displays, liquid-crystal displays (LCDs), plasma displays, image projectors, or other display types now known or later developed. It should be understood, that various output device(s) 222 may also be integrated via local interface 208 and/or via network-interface device(s) 224 to other well-known devices such as plotters, printers, copiers, etc.

Local interface 208 may also be in communication with input/output devices that communicatively couple the general-purpose computer 20 to the network 40 (FIG. 1). These two-way communication devices include, but are not limited to, modulators/demodulators (modems), network-interface cards (NICs), radio frequency (RF) or other transceivers, telephonic interfaces, bridges, and routers. For simplicity of illustration, such two-way communication devices are represented by network interface(s) 224.

Local interface 208 is also in communication with time-code generator 230. Time-code generator 230 provides a time-varying signal to IPE 300. The time-varying signal can be generated from an internal clock within the general-purpose computer 20. Alternatively, the time-code generator 230 may be in synchronization with an externally generated timing signal. Regardless of its source, time-code generator 230 forwards the time-varying signal that is received and applied by IPE 300 each time an image-processing function is performed on an image under the control and management of IPS 10.

When the general-purpose computer 20 is in operation, the processor 200 is configured to execute software stored within the memory 210, to communicate data to and from the memory 210, and to generally control operations of the general-purpose computer 20 pursuant to the software. The IPE 300 and the operating system 214, in whole or in part, but typically the latter, are read by the processor 200, perhaps buffered within the processor 200, and then executed.

The IPE 300 can be embodied in any computer-readable medium for use by or in connection with an instruction-execution system, apparatus, or device, such as a computer-based system, processor-containing system, or other system that can fetch the instructions from the instruction-execution system, apparatus, or device, and execute the instructions. In the context of this disclosure, a “computer-readable medium” can be any means that can store, communicate, propagate, or transport a program for use by or in connection with the instruction-execution system, apparatus, or device. The computer-readable medium can be, for example but not limited to, an electronic, magnetic, optical, electromagnetic, infrared, or semiconductor system, apparatus, device, or propagation medium now known or later developed. Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

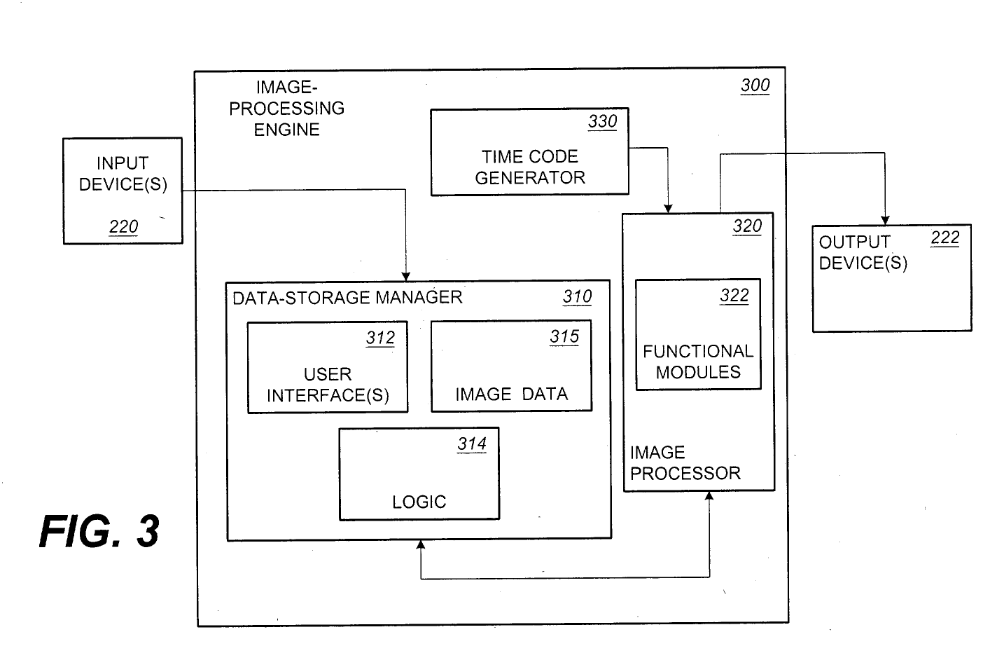

Reference is now directed to FIG. 3, which presents an embodiment of a functional block diagram of IPE 300. As illustrated in FIG. 3, the IPE 300 comprises a data-storage manager 310 and an image processor 320 that interact with each other as well as input device(s) 220 and output device(s) 222 or other distributed-memory devices associated with the network 40 under the direction of general-purpose computer 20. The IPE 300 also includes a time code generator. The embodiment illustrated in FIG. 3 depicts the data-storage manager 310 with user interface(s) 312 and image data 315. Those skilled in the art will understand that the image data 315 may include multiple images accessed and stored under multiple image-processing data protocols.

As illustrated in FIG. 3, data-storage manager 310 is in communication with input device(s) 220 and image processor 320. Data-storage manager 310 includes one or more user interface(s) 312 configured to enable a user of the general-purpose computer 20 (FIG. 1) to input one or more image-selection parameters that can be used by logic 314 to identify which images stored within image data 315 meet the intended image-selection criteria. Data-storage manager 310 is configured to manage a plurality of images and preferably, a plurality of image-data types.

In accordance with the present system and method, user interface(s) 312 under the control of data-storage manager 310 includes logic configured to receive an indication of a period-of-interest from an operator of the general-purpose computer 20. The period-of-interest includes a range of time over which the IPS 10 may have processed multiple images. IPS 10 processes an image when it acquires, edits, stores, or otherwise manipulates the underlying pixel information that defines the image. The range of time can include years, months, days, hours, or any other period of time that an operator may be interested to investigate whether IPS 10 processed images during the period including a.m. or p.m. hours of a specific day. Selecting previously processed images by the time (e.g., the date) the image was processed provides an operator with an improved function for locating images (i.e., files) that may be stored with difficult to remember file or image names.

For example, an operator of the general-purpose computer 20 may want to forward a copy of an image that was originally acquired in the morning hours of Jul. 4, 2002. In order to forward a copy of the image, generally the operator must locate or otherwise identify the image. Often the image is saved or otherwise stored to data-storage manager 310 under one or more file management schemes.

For example, an image file may have been provided a filename such as, “scan0001.jpg” by an automated procedure implemented in hardware, firmware, and/or software associated with scanner 24 or a file-management system within IPS 10. In operation, the operator forwards a period-of-interest via one or more input devices 220 working in connection with one or more user interface(s) 312 to logic 314. Preferably, user interface 312 includes a representation of a calendar. The period-of-interest, whether it is a year, month, week, day, or a portion of a calendar day, is selected by an operator via one or more input devices 220. The input device(s) 220 may interact with general-purpose computer 20 to enable visual feedback to the operator regarding the period-of-interest. Logic 314 determines which of the one or more images stored within image data 315 were processed within the period-of-interest. Logic 314 forwards a representation, such as a thumbnail of the identified image(s), to an output device 222 in communication with IPS 10. In addition, the output device 222 illustrates or otherwise distinguishes the period-of-interest. By way of example, the output device 222 distinguishes the period-of-interest by highlighting, increasing the size of time division in the representation, changing the color of the alphanumeric characters within the period-of-interest in the representation, moving the period-of-interest to the foreground, etc.

As described above, image processing can include image acquisition, receipt, and storage. Each of these image-processing operations or functions can be performed by image processor 320 using one or more functional modules 322. As further illustrated in FIG. 3, time code generator 330 communicates a timestamp (not shown) that is associated with the underlying image data 315 when the underlying pixels are processed in functional modules 322. Consequently, each image-processing operation is associated with a corresponding timestamp. The combination of the timestamp and the function performed on image data 315 defines an image attribute (e.g., an image time, an image-acquisition time, an image-storage time, etc.) that can be used by IPS 10 to identify individual images.

In addition to these examples, other image attributes can be associated with individual images as well. In other words, an operator of the IPS 10 can assign any time or date to the image that could be used to identify the image. An operator of IPS 10 can assign an image date to a print or photograph scanned or otherwise added to IPS 10. For example, an operator of IPS 10 could scan a photograph that was originally taken on Dec. 7, 1941 and associate that date with the image under the image attribute “image date.” An image date may be useful for locating stored images of family photographs when the operator can remember that a particular family event (e.g., a wedding) occurred in a particular year or month and year but cannot remember where the images were stored or when they were scanned or otherwise acquired by IPS 10.

Furthermore, the operator assigned time or date can be given a user-assigned image attribute or label. For example, an operator of the IPS 10 could scan a photograph that was originally taken on Dec. 7, 1941 and associate that date with the image under the label “Pearl Harbor” or “U.S.S. Arizona.” A second processing identifier could be associated with the image as an indication of when the photograph was acquired by IPS 10. This image-processing identifier or image-acquisition date (i.e., the scanned date or scanned time) can be associated with an image when it is acquired or otherwise received by IPS 10. Note that the image-acquisition date could also be associated with an image received as an email attachment, a file transfer protocol download, or other file transfer. In these examples, IPS 10 is configured to automatically assign an image-acquisition time to the received image. Consequently, the image can be retrieved via multiple mechanisms. The mechanisms can be used separately or in various combinations to further locate and retrieve stored images within IPS 10. For example, an operator can locate images by the image acquisition date, by searching on a user-assigned image attribute (e.g. names of subjects in the images, the location where the image was taken, etc.), or by searching for images using a combination of attributes associated with previously stored images.

Logic 314 uses a timestamp responsive to a continuous time representation forwarded from time-code generator 330 to identify when a particular processing function has been performed on a particular image. Alternatively, logic 314 can work together with a file-management system that associates a last update time with each individual file. The timestamp or other indication of the last update time can be encoded and inserted into a file header, a separate database, or encoded within the image information.

Regardless of the specific implementation for associating a time with an image, logic 314 forwards an indication of the identified images to image processor 320. The image processor 320 prepares a representation of the image and forwards the representation to one or more output device(s) 222 identified by the operator. In some embodiments, the image processor 320 buffers the identified images and forwards a thumbnail representation of images that were processed within the period-of-interest to a graphical-user interface provided by user interface(s) 312. Image processor 320 also includes functional modules 322 (e.g., modules for color processing, contrast control, brightness, image-data compression, image-data manipulation, etc.) that enable the image processor 320 to manipulate the underlying pixel array that forms each image.

Note that logic 314 within data-storage manager 310 can be configured to identify the particular image processing operation as well. For example, an operator of the general-purpose computer 20 may be attempting to locate an image that the operator edited via imaging processing software associated with IPS 10 on or around the 10^{th} day of July. The operator can selectively enter a range of dates (e.g., from Jun. 15, 2002 to Jul. 15, 2002) and an indication that only edited images are desired in an effort to locate the previously edited image. As described above, the period-of-interest defined by the start and end dates provided by the operator are forwarded to logic 314. Logic 314 then identifies images within image data 315 that were edited on and/or between Jun. 15, 2002 and Jul. 15, 2002.

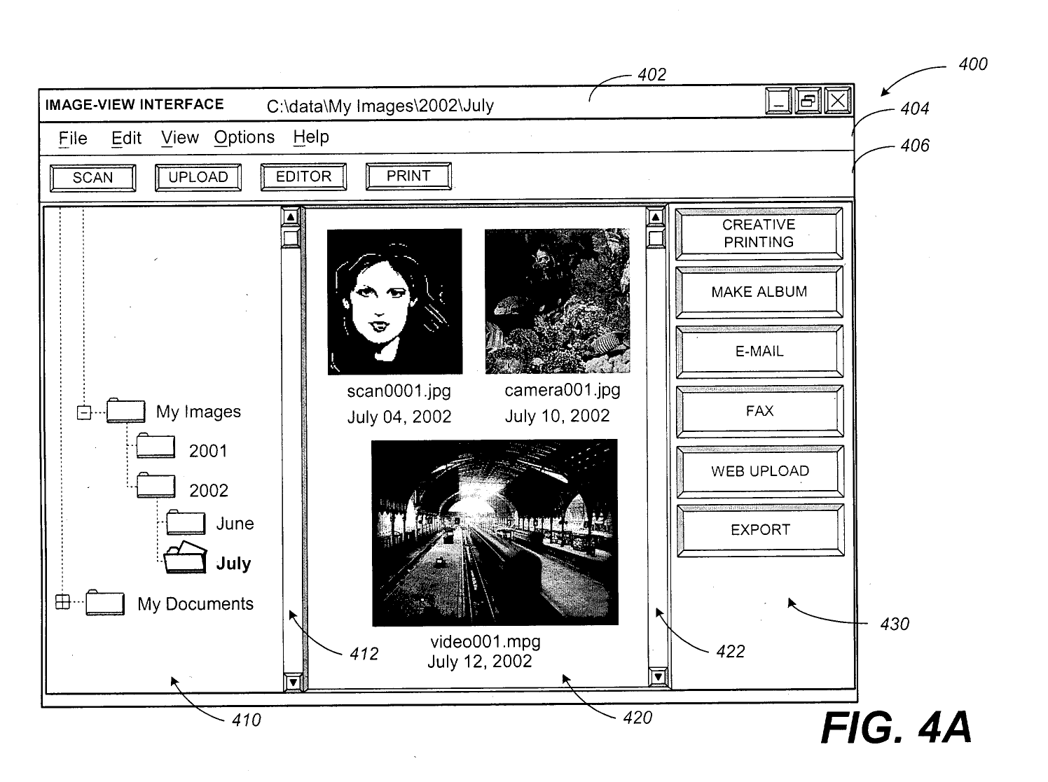

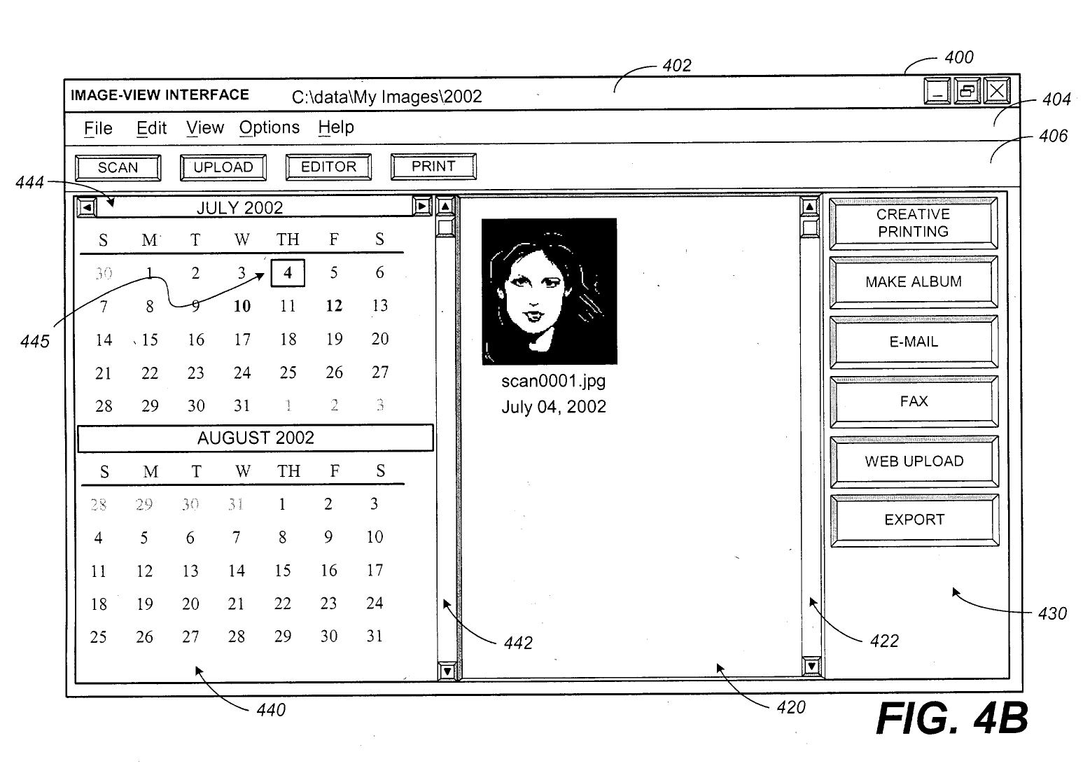

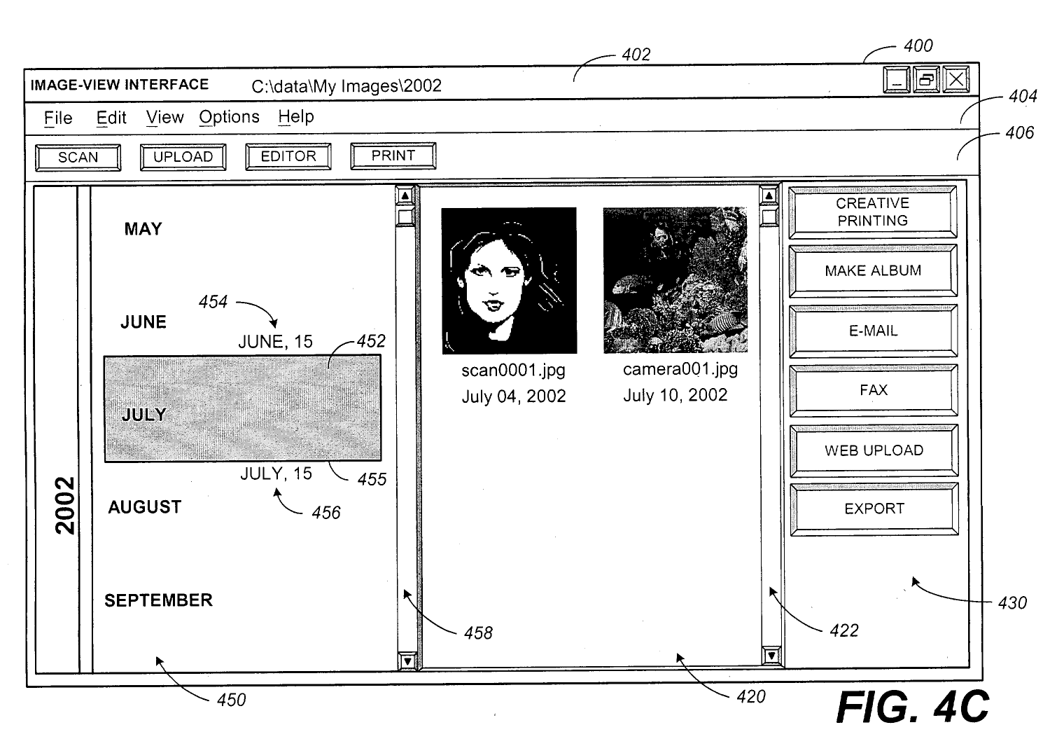

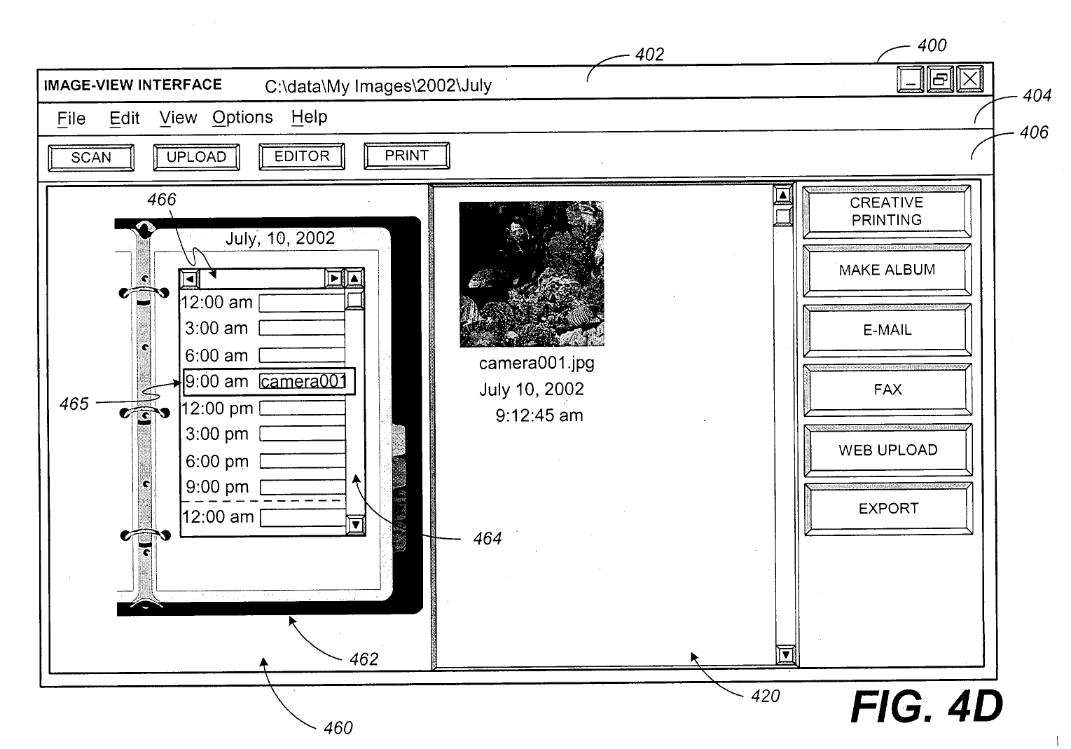

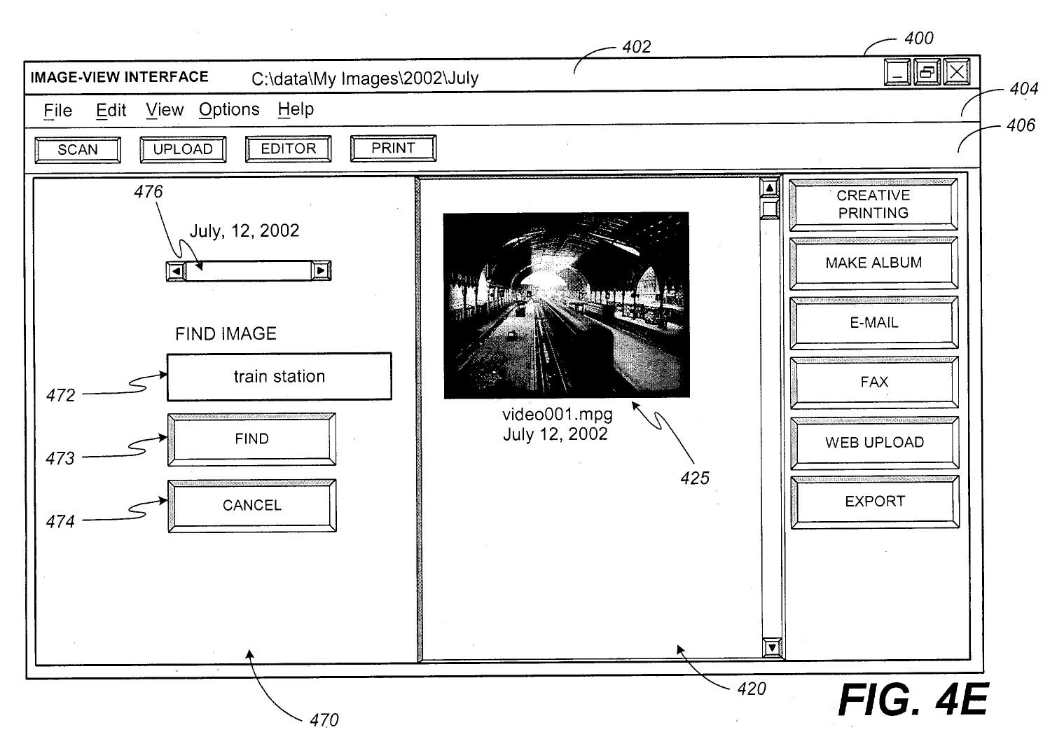

FIGS. 4A-4E illustrate various embodiments of example graphical-user interfaces (GUIs) that are operable with the data-storage manager 310 of the IPE 300. More specifically, FIG. 4A generally illustrates a GUI denoted by reference numeral 400 that may be provided by the data-storage manager 310 to enable operator access to a plurality of images (i.e., image data 315) that may be stored in memory 210 under the control and management of data-storage manager 310. GUI 400 includes a window label 402, a pull-down menu bar 404, a functional push-button menu bar 406, a directory frame 410, an image frame 420, and an advanced image-processing frame 430.

Window label 402, as illustrated in FIG. 4A, includes an application label (e.g., “Image-view interface”) and a file-structure locator (e.g., “C:\data\My Images\2002\July”) in addition to push buttons commonly provided in Windows® operating system based application interfaces for minimizing the application-interface window, maximizing the application-interface window, and closing (i.e., terminating) the application. Windows® is the registered trademark of the Microsoft Corporation of Redmond, Wash., U.S.A.

Pull-down menu bar 404 includes a number of commonly provided labels for accessing a menu of associated functions. Each individual menu can be selectively displayed by using a pointing device associated with the general-purpose computer 20 to place a cursor or other graphical icon over the desired label and selecting an input indicator such as a left-mouse pushbutton. As is known, once the pull-down menu functions are displayed, a desired functional operation can be selected by similarly locating the cursor over the label of the function and selecting the left-mouse pushbutton. In accordance with standard programming procedure for GUI pull-down menus, once an operator of the general-purpose computer 20 highlights and selects a function, corresponding logic associated with the IPE 300 is invoked and processed.

Functional push-button menu bar 406 includes a number of common image-processing functions (e.g., scan, upload, editor, and print) that may invoke one or more executable commands on the general-purpose computer 20. For example, when an operator of the IPE 300 desires to acquire a new digital-image of a source object placed on the scan bed of scanner 24, the general-purpose computer 20 is programmed to start a computer program that operates the scanner 24 so that an image is acquired. GUI 400 can be programmed to provide functional push buttons for uploading images to a network-coupled data-storage device (generally via a network application interface), image editing, and/or printing, among others.

Directory frame 410 includes a graphical representation of the data-storage units or folders often associated with files accessible on a memory device communicatively coupled to general-purpose computer 20. As illustrated in FIG. 4A, the data-storage manager 310 is configured to arrange image data in folders based on when the image was acquired by IPS 10. An operator of the general-purpose computer 20 may selectively browse representations of images stored within image data 315 by locating the cursor over the desired folder and selecting the folder. As indicated in the example, GUI 400 depicts an IPE 300 response associated with a request to browse images acquired (i.e., scanned, photographed, transferred, or otherwise added) by IPS 10 during the calendar month of July in the year 2002. As illustrated in FIG. 4A, directory frame 410 is associated with a frame navigator 412 that includes an up-arrow push button, a down-arrow push button, and an up-down scroll-slide button.

The directory frame 410 is one example of many selection tools that can be used to assist an operator of the IPS 10 in locating one or more images processed by the IPS 10. For example, the directory frame 410 can include an additional interface suited to receive time-based data entries from the operator. The additional interface (not shown) can be arranged to receive a start time and a stop time of a desired range of time during which an image-of-interest may have been processed. The start and stop times entered via the additional interface can be combined with information conveyed within the directory frame 410 as described above to perform a more detailed search of processed images.

In addition to combining search criteria conveyed from the directory frame and an additional interface, GUI 400 can be configured to allow the user to switch from one search criteria to another. For example, when the directory frame 410 is configured with an interface configured to receive a search term, an operator of the IPS 10 could search for a particular image by subject-matter keyword, calendar information, and/or an indication that a number of images were processed during a relatively brief period of time (i.e., an image cluster). An image cluster can occur because a calendar or other time-based representation is used to facilitate locating one or more desired images via GUI 400. Under some conditions, a plurality of images associated with a processing step within a relatively brief duration (in comparison with the displayed time period) may appear as an image cluster on the interface.

IPS 10 is not just limited to using time by itself, but also includes using time in conjunction with other search criteria. For example, by combining a period-of-interest and a keyword search on an operator assigned image attribute associated with a stored image, an operator of IPS 10 could use GUI 400 to find pictures of a daughter's birthday party by entering a subject-of-interest such as “party” within a period-of-interest that includes both the daughter's birth date (as indicated on a calendar representation) and the dates of any associated celebrations.

An image attribute can be any series of alphanumeric characters including a string that can be used to describe an associated image. For example, an image of a child playing baseball can be associated with the following image attributes: the child's name, baseball, a team name or sponsor, etc. As described above, an operator of IPS 10 may be scanning or otherwise acquiring an image of an event captured in a photograph. Preferably, the operator enters one or more operator assigned image attributes in addition to the processing time image attributes (e.g., image date and image acquisition date). While it is preferred that one or more operator assigned image attributes are associated with an image when the image is first added to IPS 10, IPS 10 may be configured with an interface that allows an operator to associate one or more image attributes with previously stored images.

In addition an operator of IPS 10 may be presented with one or more interfaces for entering or otherwise selecting a subject-of-interest. When an operator has elected to search for previously processed images using a keyword search, logic 314 is configured to identify any matches between the one or more operator assigned image attributes and the operator entered subject-of-interest. Images identified as matching the search criteria are then forwarded to the one or more output devices 222.

In alternative embodiments (not illustrated), GUI 400 could also include an interface such as a selection tool area that shows whatever selection tool (e.g., monthly calendar, subject matter term search, both, etc.) has been chosen by an operator of the IPS 10. In this way, the operator is provided flexibility, convenience, and feedback when selecting one or more image-search criteria.

Image frame 420 is configured to provide image representations produced from the pixel information associated with files in image data 315 that meet the selection criteria indicated in directory frame 410. In some cases, an image representation of a single frame will be used to identify a series of images such as a video. In the illustrated example, three images are presented with a first image labeled, “scan001.jpg, Jul. 4, 2002;” a second image labeled, “camera0001.jpg, Jul. 10, 2002;” and a third image labeled, “video0001.mpg, Jul. 12, 2002.” As can be determined by the label associated with the images, each of the images presented in image frame 420 was acquired within the period-of-interest entered (i.e., the month of July) by an operator of the general-purpose computer 20 as indicated in directory frame 410. As is further illustrated in FIG. 4A, image frame 420 is associated with a frame navigator 422 that includes an up-arrow push button, a down-arrow push button, and an up-down scroll-slide button for navigating a plurality of image representations that are not visible within the area provided within GUI 400.

Advanced image-processing frame 430 includes one or more functional push buttons configured to invoke logic associated with other application programs that may be operable on the general-purpose computer 20 of IPS 10. For example, an e-mail push button may open a default e-mail application, generate a new message within a message editor, and attach a copy of selected images within image frame 420. It will be understood by those skilled in the art that multiple mechanisms can be programmed to enable an operator of the general-purpose computer 20 to select one or more images that fall within the period-of-interest. The selected images can then be forwarded to image processor 320 or other external application programs to enable various image solutions. Although GUI 400 includes “creative printing,” “make album,” “e-mail,” “fax,” “web upload,” and “export” advanced image-processing functional selections, the present system and method are not limited to these functions.

The image file labels associated with the thumbnail representations of the images in GUI 400 can be readily interpreted as to their acquisition source, the image-file type (e.g., joint-photographics expert-group file format or JPEG), and the date of acquisition. However, it is often the case that image-acquisition systems generate obscure filenames that do not identify the image data with information regarding the acquisition source, image-data file type, acquisition time, etc. IPE 300 can be associated with IPS 10 to enable an operator to enter a period-of-interest from a calendar view to browse previously acquired images.

FIG. 4B presents an alternative to the directory frame 410 illustrated and described with regard to FIG. 4A for entering a period-of-interest in IPE 300. As illustrated in FIG. 4B, the directory frame 410 can be replaced with a calendar frame 440 that depicts one or more calendar months within the area provided in GUI 400. Calendar frame 440 is associated with a vertically arranged frame navigator 442 that includes an up-arrow push button, a down-arrow push button, and an up-down scroll-slide button for navigating the months of the calendar. Calendar frame 440 is also associated with a horizontally arranged frame navigator 444 that includes a left-arrow push button, a right-arrow push button, and a left-right scroll-slide button for navigating the years of the calendar.

Note that the calendar frame 440 graphically differentiates the following dates: July 4^{th}, July 10^{th} and July 12^{th}. This is done in order to indicate to the user that there are one or more stored images associated with these particular dates. In this example, “scan0001.jpg” is associated with July 4, 2002; “camera001.jpg” is associated with Jul. 10, 2002; and “video0001.mpg” is associated with July 12, 2002. (“Camera001.jpg” and “video001.mpg” are each illustrated in FIG. 4A.) “. In this example, the dates are differentiated by displaying July 4^{th}, July 11^{th} and July 12 in bolded text. In other embodiments, dates may be differentiated in other ways (e.g., via text color, text size, text style, etc).

In operation, a user of the general-purpose computer 20 uses a mouse or other pointing device associated with the general-purpose computer 20 to select a date or a range of dates as described above in association with other functions. Date and/or ranges of dates may also be entered using a keyboard or other data input devices now known or later developed. A range of dates can be identified by selecting and dragging either of the borders of the range selection frame 445.

FIG. 4B illustrates the condition of the GUI 400 after an operator of the IPE 300 has selected Jul. 4, 2002 from the calendar frame 440. As shown, only the thumbnail of the image acquired on Jul. 4, 2002 is presented in image frame 420. Note that if the operator were to select July 10^{th}” from the calendar frame 440, for example, the computer 20 operates to display a thumbnail of “camera001.jpg”. If the operator were to select the range of dates from July 4^{th}-July 12^{th}, the computer 20 operates to display, all within image frame 420, a thumbnail of “scan001.jpg”; “camera001.jpg” and “video0001.jpg.”

FIG. 4C presents an alternative to the directory frame 410 and the calendar frame 440 illustrated and described with regard to FIGS. 4A and 4B, respectively, for entering a period-of-interest in IPE 300. As illustrated in FIG. 4C, timeline frame 450 can replace the directory frame 410 or calendar frame 440. Timeline frame 450 includes a linear representation of time that encompasses a range-of-interest indicator 452. Range-of-interest indicator 452 is identified by frame 455. Timeline frame 450 also includes a vertically arranged frame navigator 458 that includes an up-arrow push button, a down-arrow push button, and an up-down scroll-slide button for navigating the months of the calendar.

In operation, a user of the general-purpose computer 20 uses a mouse or other pointing device associated with the general-purpose computer 20 to select a date or a range of dates as described above in association with other functions. A range of dates can be identified by selecting and dragging either of the start-of-range border 454 herein labeled Jun. 15, 2002 and/or the end-of-range border 456 labeled Jul. 15, 2002.

FIG. 4C illustrates the condition of the GUI 400 after an operator of the IPE 300 has selected to view images processed on or between Jun. 15, 2002 and Jul. 15, 2002. As shown, thumbnail representations of the images acquired on Jul. 4, 2002 and Jul. 10, 2002 are presented in image frame 420.

FIG. 4D presents an alternative to frames 410, 440, and 450 illustrated and described with regard to FIGS. 4A-4C, respectively, for entering a period-of-interest in IPE 300. As illustrated in FIG. 4D, personal-organizer frame 460 can replace the frames 410, 440, or 450. Personal-organizer frame 460 includes a representation of a day 462 that includes a range-of-interest frame 465. Day 462 is divided into three-hour segments in the illustrated example. Those skilled in the art will understand that the IPE 300 can be programmed to represent the day using various time divisions as may be desired. As further illustrated in FIG. 4D, personal-organizer frame 460 includes a vertically arranged frame navigator 464 that includes an up-arrow push button, a down-arrow push button, and an up-down scroll-slide button for navigating the months of the calendar. In addition, personal-organizer frame 460 includes a horizontally arranged frame navigator 466 that includes a left-arrow push button, a right-arrow push button, and a left-right scroll-slide button for navigating the years of the calendar.

In operation, a user of the general-purpose computer 20 uses a mouse or other pointing device associated with the general-purpose computer 20 to select a date or a range of dates as described above in association with other functions. A range of dates can be identified by selecting and maneuvering range-of-interest frame 465 over the displayed time segments comprising day 462.

FIG. 4D illustrates the condition of the GUI 400 after an operator of the IPE 300 has selected to view images processed on or between 9:00 am to 12:00 pm on Jun. 10, 2002. As shown, a thumbnail representation of the image acquired on July 10, 2002 at 9:12:45 am is presented in image frame 420.

FIG. 4E presents an alternative to frames 410, 440, 450, and 460 illustrated and described with regard to FIGS. 4A-4D, respectively, for entering a period-of-interest in IPE 300. As illustrated in FIG. 4E, find-image frame 470 can replace and/or be presented alongside one or more of frames 410, 440, 450 and 460. Find-image frame 470 includes a representation of a date-of-interest 476. Date-of-interest 476 is entered by an operator or otherwise selected from a graphical interface provided by IPS 10. As shown in FIG. 4E, find-image frame 470 further includes subject-of-interest entry field 472, find pushbutton 473, and cancel pushbutton 474. Subject-of-interest entry field 472 is configured to receive a user-selected alphanumeric string that is applied by logic to further locate and identify images processed by IPS 10. Find pushbutton 473 invokes the logic to apply the contents of the subject-of-interest entry field 472 against image attributes associated with stored images. Cancel pushbutton 474 is programmed to clear the contents of the subject-of-interest entry field 472.

FIG. 4E also illustrates that an image attribute 425 can be associated with a stored image. In the example, image “video0001.mpg” in image frame 420 is the result of an operator directed search for images processed on Jul. 12, 2002 that include the image attribute “train station.” Image attribute 425 (i.e., “train station”) can be associated with the underlying image data at any time prior to the present find operation including the time of original acquisition and storage of the image(s). Moreover, multiple image attributes can be associated with each stored image. For example, image “video0001.mpg” could be associated with image attributes 425 train station, video, moving pictures experts group file standard (MPEG), etc. in addition to one or more image-time attributes.

In operation, a user of the general-purpose computer 20 uses a mouse or other pointing device, a keyboard, a voice-activated input interface or another suitably configured input device associated with the general-purpose computer 20 to select a date-of-interest 476 and one or more subject-of-interest strings via subject-of-interest entry field 472.

It should be understood that while FIGS. 4A-4E present various GUIs that one or more non-graphical-user interfaces can be programmed for operation with the general-purpose computer 20 (FIG. 2). The claimed system and method is not limited to the GUI embodiments disclosed herein.

As described above, the period-of-interest can be input in many ways facilitated by the various calendar views. For example, the operator of the IPS 10 can graphically highlight the period-of-interest by dragging a pointing device over the desired date range on a representation of a calendar. As also described above, an operator of IPS 10 can indicate a specific day, week, month, etc. around a date as the period-of-interest in an appropriately configured interface associated with IPE 300. The above selection criteria can be used in conjunction with a subject matter-term search to further identify images.

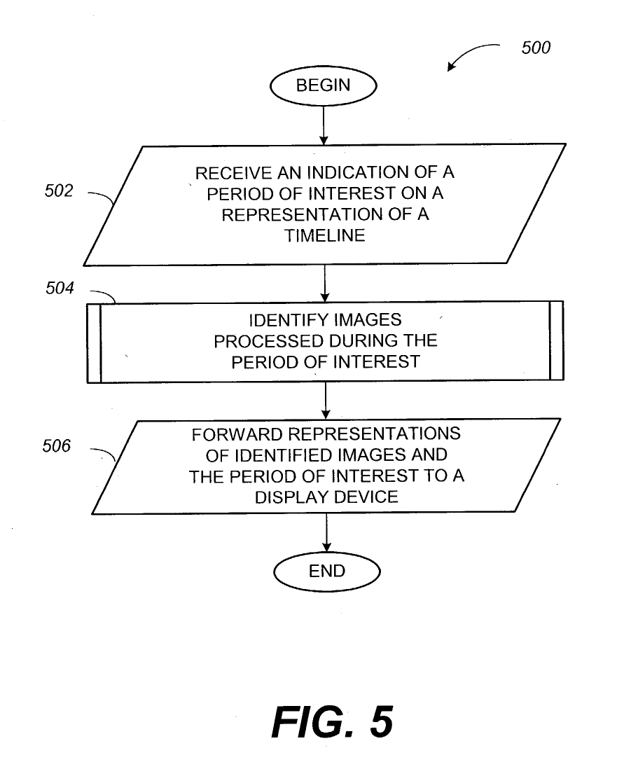

Reference is now directed to the flow chart illustrated in FIG. 5, which illustrates an embodiment of a method for displaying an image that can be implemented by the general-purpose computer 20 and other communicatively coupled image-processing devices of the IPS 10 of FIG. 1. In this regard, IPE 300 logic herein illustrated as method 500 may begin with block 502 where IPE 300 receives an indication of a period-of-interest on a representation of a timeline. As illustrated and described above in association with FIGS. 4A-4E the representation may be in the form of a calendar, a timeline, a personal organizer, etc. Alternatively, the representation may be received via an interface that enables a user of the general-purpose computer 20 to enter a start time and an end time, thus identifying a period-of-interest.

In block 504, the IPE 300 applies the period-of-interest against previously stored images to determine which images were processed during the identified period. Next, as shown in block 506, the IPE 300 is programmed to forward a representation of each image identified in block 504 along with an indication of the period-of interest to a display device. Alternatively, the IPE 300 can be programmed to forward images to a printer or other hard-copy output device.

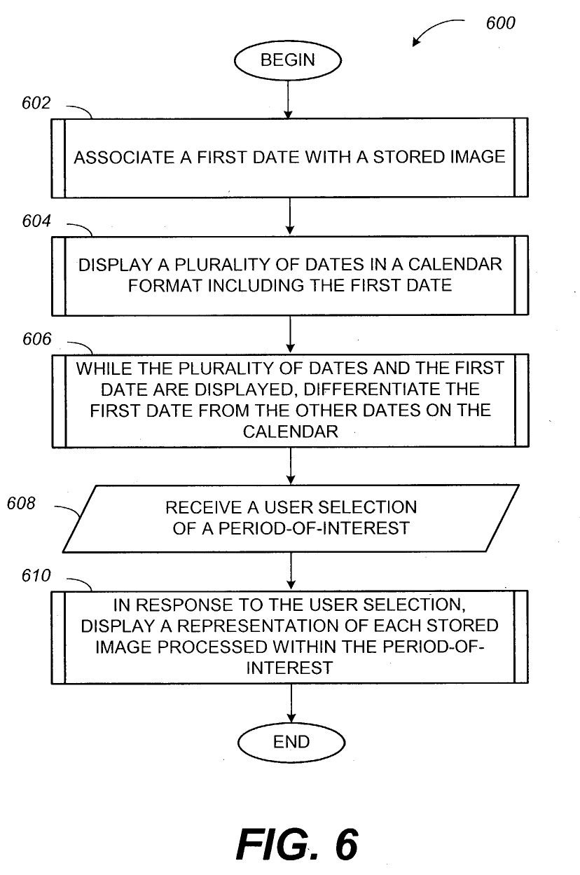

FIG. 6 is a flow chart illustrating an embodiment of a method for displaying a date associated with an image that may be implemented by the by the general-purpose computer 20 and other communicatively coupled image-processing devices of the IPS 10 of FIG. 1. In this regard, IPE 300 logic herein illustrated as method 600 may begin with block 602 where the general-purpose computer 20 or a communicatively coupled image-processing device associates a first date with a stored image. As shown in block 604, the general-purpose computer 20 or a communicatively coupled image-processing device is programmed to display a plurality of dates in a calendar format. Preferably, the display includes a representation of the first date. As further shown in block 606, the display differentiates the first date from other dates on the calendar.

Thereafter, as indicated in input block 608, the general-purpose computer 20 or a communicatively coupled image-processing device is programmed to receive a user selection of a period-of-interest. In response to the user selection, as illustrated in block 610, the general-purpose computer 20 or a communicatively coupled image-processing device is programmed to display a representation of each stored image processed within the period-of-interest.

Any process descriptions or blocks in the flow charts presented in FIGS. 5 and 6 should be understood to represent modules, segments, or portions of code or logic, which include one or more executable instructions for implementing specific logical functions or steps in the associated process. Alternate implementations are included within the scope of the present system and method in which functions may be executed out of order from that shown or discussed, including substantially concurrently or in reverse order, depending on the functionality involved, as would be understood by those reasonably skilled in the art after having become familiar with the teachings of the present system and method.

I claim:

1. A method for presenting a previously stored image, the method comprising:
receiving information corresponding to a period-of-interest;
identifying an image processed within the period-of-interest; and
forwarding a representation of the image to a display device, wherein the display device presents the representation of the image and a representation of a system for fixing the beginning, length, and divisions of a year, the representation of the system illustrating the period-of-interest.

2. The method of claim 1, wherein the image is a frame selected from a video.

3. The method of claim 1, wherein receiving further comprises an assigned time attribute, the assigned time attribute associated with the image, and forwarding commences when the assigned time attribute is within the period-of-interest.

4. The method of claim 1, wherein receiving further comprises a subject-of-interest, and forwarding commences when the subject-of-interest matches an image attribute associated with the stored image.

5. The method of claim 4, wherein the image attribute is an image date.

6. The method of claim 4, wherein the image attribute is an image acquisition date.

7. The method of claim 4, wherein the image attribute is a user-defined label.

8. The method of claim 1, wherein the period-of-interest is a day.

9. The method of claim 1, wherein receiving comprises selecting a start time and an end time.

10. The method of claim 9, wherein the start time and the end time comprise iconic representations on a representation of a personal organizer.

11. The method of claim 9, wherein the start time and the end time comprise iconic representations on a representation of a timeline.

12. The method of claim 1, wherein the period-of-interest is specifically marked within the system.

13. The method of claim 1, wherein receiving comprises selecting a date on the representation of the system.

14. The method of claim 1, wherein identifying comprises finding an image associated with a timestamp within an image acquisition-time range.

15. The method of claim 1, wherein identifying comprises finding an image associated with a timestamp within an image receipt-time range.

16. The method of claim 1, wherein identifying comprises finding an image associated with a timestamp within an image storage-time range.

17. An image-processing system, comprising:
means for storing a plurality of images;
means for determining when each of the plurality of images was processed;
means for receiving an input indicative of a period-of-interest; and
means for presenting a representation of each the plurality of images and illustrating the period of interest on a representation of a system for fixing the beginning, length, and divisions of a year, when each of the plurality of images was processed during the period-of-interest.

18. The system of claim 17, wherein the means for receiving comprises a user interface that provides a representation of a calendar.

19. The system of claim 18, wherein the means for receiving comprises a user interface that receives a date.

20. The system of claim 17, wherein the means for receiving comprises a user interface that provides a representation of a timeline.

21. The system of claim 20, wherein the means for receiving comprises a user interface that provides a start time and an end time.

22. The system of claim 17, wherein the means for receiving comprises a graphical-user interface that provides a representation of a personal organizer.

23. The system of claim 17, wherein the means for receiving further comprises an assigned time attribute associated with the plurality of images, and wherein the means for presenting presents image representations associated with an assigned time attribute within the period-of-interest.

24. The system of claim 17, wherein the means for receiving further comprises a subject-of-interest, and wherein the means for presenting presents image representations associated with a subject-of-interest that matches an image attribute associated with the images.

25. The system of claim 24, wherein the image attribute comprises a user-defined label.

26. The system of claim 17, wherein the means for determining comprises information indicative of an image time associated with the image, the information selected from the group consisting of year, month, day, hour, minute, and second.

27. The system of claim 17, wherein the means for determining comprises information indicative of an image acquisition time associated with the image, the information selected from the group consisting of year, month, day, hour, minute, and second.

28. The system of claim 17, wherein the means for determining comprises information indicative of an image storage time associated with the image.

29. The system of claim 17, wherein the means for determining further comprises retrieving the image, the image having been stored in a data folder of a data-management system, the data-management system using a plurality of data folders identified and arranged as a calendar.

30. The system of claim 17, wherein the means for presenting a representation of each the plurality of images displays a sample frame selected from a video, the sample frame being selectable to enable an operator of the system to observe the video.

31. A computer-readable medium having processor-executable instructions stored thereon which, when executed by a processor, direct the processor to:
apply an input indicative of a period-of-interest to logic that determines when an image was processed during the period-of-interest; and
send a representation of the image and the period of interest indicated by the input to a display device communicatively coupled to the processor when the image was processed within the period-of-interest, and wherein the display device illustrates the period-of-interest on a representation of a calendar.

32. The computer-readable medium of claim 31, wherein the processor-executable instructions are configured to accept an input that identifies a calendar division.

33. The computer-readable medium of claim 32, wherein the calendar division is selected from the group consisting of year, month, and day.

34. The computer-readable medium of claim 32, wherein the input identifies at least a portion of a day.

35. The computer-readable medium of claim 34, wherein the portion of the day is selected from the group consisting of a.m., p.m., hour, minute, and second.

36. The computer-readable medium of claim 31, wherein the processor-executable instructions are configured to accept a subject-of-interest;
apply the subject-of-interest to logic that determines if an image was associated with an image attribute that matches the subject-of-interest; and
send a representation of the image and the subject-of-interest to a display device communicatively coupled to the processor when an image attribute associated with the image matches the subject-of-interest.

37. The computer-readable medium of claim 31, wherein the processor-executable instructions are configured to determine when the image representation was processed in a manner selected from the group consisting of acquired, received, and stored.

38. An image-processing system, comprising:
a user interface configured to receive a user-directed input corresponding to a period-of-interest;
a processor communicatively coupled to the user interface, the processor configured to forward a representation of a previously processed image when the previously processed image was processed within the period-of-interest; and
an output device communicatively coupled to the processor, the output device configured to receive and present the representation of the previously processed image and the period-of-interest in a representation of a calendar.

39. The system of claim 38, further comprising:
a time-code generator communicatively coupled to the processor, the time-code generator configured to produce an output responsive to a representation of the present time, and wherein the processor associates the output with the previously processed image.

40. The system of claim 39, wherein the processor associates the output with the previously processed image when the image is acquired.

41. The system of claim 39, wherein the processor associates the output with the previously processed image when the image is stored in a memory.

42. The system of claim 38, wherein the user interface is further configured to receive a user-directed subject-of-interest.

43. The system of claim 42, wherein the processor is configured to forward a representation of a previously processed image when the subject-of-interest matches an image attribute associated with the previously processed image.

44. The system of claim 43, wherein the image attribute is an image date.

45. The system of claim 43, wherein the image attribute is an image acquisition date.

46. The system of claim 38, wherein the user interface is a graphical-user interface.

47. The system of claim 38, wherein the user interface presents a representation of at least a portion of a day.

48. The system of claim 47, wherein the portion of the day is selected from the group consisting of a.m., p.m., hour, minute, and second.

49. A method, comprising:
associating a first date with at least one stored image;
displaying a plurality of dates, including the first date;
while the dates are being displayed and in response to the first date being associated with at least one stored image, differentiating the displayed first date.

50. The method of claim 49, wherein associating a first date with at least one stored image comprises identifying stored images processed during the first date.

51. The method of claim 49, wherein differentiating the displayed first date comprises graphically distinguishing the displayed first date from a subset of the plurality of dates.

52. The method of claim 49, further comprising:
receiving a user selection of the displayed first date;
in response to the selection, displaying a representation of each one of the at least one stored images.

53. The method of claim 52, wherein displaying a representation of each one of the at least one stored images comprises identifying images associated with a timestamp that corresponds to a time within an image-acquisition time range.

54. The method of claim 52, wherein displaying a representation of each one of the at least one stored images comprises identifying images associated with a timestamp that corresponds to a time within an image-receipt time range.

55. The method of claim 52, wherein displaying a representation of each one of the at least one stored images comprises identifying images associated with a timestamp that corresponds to a time within an image-storage time range.

56. The method of claim 49, wherein displaying the plurality of dates comprises a calendar form.
